(19) United States
(12) Patent Application Publication
(10) Pub. No.: US 2003/0112771 A1
(43) Pub. Date: Jun. 19, 2003

(54) Device for routing digital data flows and in particular for routing packet transmission data flows

(76) Inventors: Jean-Yves Leroux, Ceyreste (FR); Sebastien Dussutour, Istres (FR)

Correspondence Address: GREENBLUM & BERNSTEIN, P.L.C., 1950 ROLAND CLARKE PLACE, RESTON, VA, 20191, US

(21) Appl. No.: 10/169,769

(22) PCT Filed: Aug. 30, 2001
(86) PCT No.: PCT/FR01/02696

(30) Foreign Application Priority Data
Aug. 30, 2000 (FR) 00/11058

(51) Int. Cl. H04B 7/185; H04L 12/66

(52) U.S. Cl. 370/316; 370/352

(57) ABSTRACT

The invention concerns a device for routing digital data flows. It consists of a box (4) equipped with a tuner (6′) connected to a satellite antenna (7′) or a data distribution network, a packet demultiplexer for receiving digital data, means for connecting it to a digital decoder (1) and to a computer (3), as well as a routing unit (9) for interconnecting all the digital flow inputs or outputs, from and to the digital decoder (1), from and to the computer (3), and from the tuner (6′). The invention concerns the digital transmission of all types of data, and in particular transmissions using packet coding consisting of a set of data routed in blocks in a network, whether radio, cable or satellite.

The object of the present invention is a device for routing digital data flows.

It relates to the digital transmission of all types of data, and in particular transmissions using packet coding constituted of a set of data routed in blocks in a network, whether radio, cable or satellite.

The reception of digital programs or services (by satellite, cable, etc.) requires a decoder that is generally in the form of a box connected to a television set or possibly a motherboard. The decoder is the portion of the receiver that allows interpreting and presenting data and not the portion that allows their decoding, or deciphering. This second portion, called access control, is sometimes completely assimilated to the decoder through misuse of the term. Current installations and equipment, whether they be a digital television set with a decoder, a video recorder or a digital decoder recorder, only allow simultaneous access to a single transmission for recording or for visualization.

The object of the device according to the present invention is to overcome this situation. Indeed, it enables recording an encrypted or non-encrypted channel on a computer (storage space) and to watch a recorded channel on the computer or television set by unscrambling it, if necessary. At a reasonable cost, it offers the possibility, by using a single access control, of selecting between three sources of data: two external sources (tuners) and an internal source (computer storing), and three outputs: two outer outputs (computer screen and television set) and an inner output (storing zone). It allows watching a program on a television set while other data is recorded and can be viewed as pre-recorded and possibly multiplexed while a program is being watched live (without being synchronous with the television flow).

It is constituted of a box equipped with a tuner connected to a satellite antenna or to a data distribution network, a packet demultiplexer for receiving digital data, means for connecting it to a digital decoder and to a computer as well as a routing unit for interconnecting all of the digital flow inputs or outputs, from and to the digital decoder, from and to the computer and from the tuner.

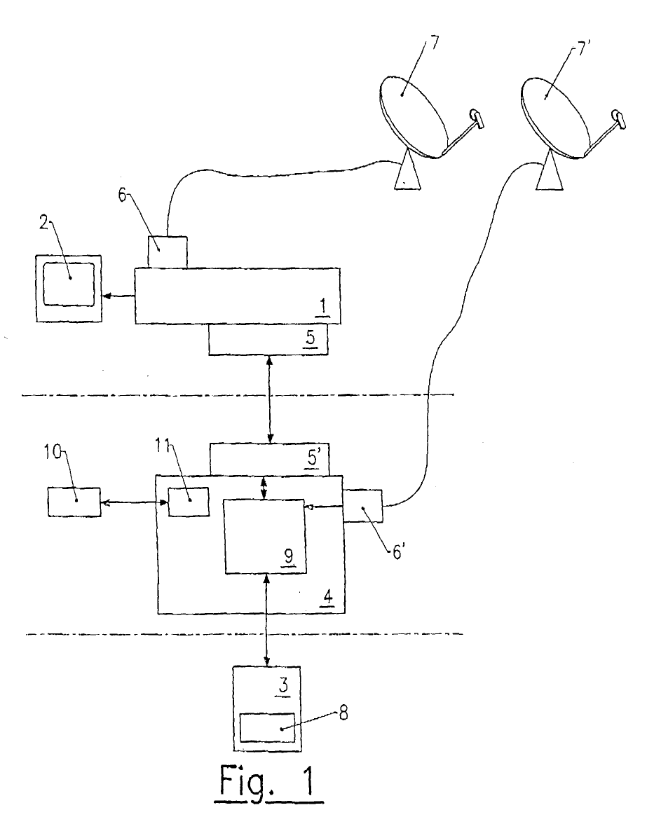

On the attached drawing, given by way of non-limiting example of one of the embodiments of the object of the invention, FIG. 1 is the synoptic diagram of an installation allowing the application of the proposed system.

This installation comprises a digital decoder 1 connected to a television set 2, a computer 3 and a box 4 for flow routing, constituting the invention in itself.

The digital decoder 1 is provided with an interface 5 supporting the digital flow (of the 1394 type or other digital connections) and with a tuner 6 connected to a satellite antenna 7 or a data distribution network.

The computer 3 equipped with a high rate outer interconnection bus (1394 (firewire), USB, Ethernet or the like), a storage space adapted to the desired quantity of data (DD, RAM, CDR, DVDR or the like), and possibly an access control software 8.

The flow router box 4 comprises an interface 5′ allowing to connect it to the digital decoder 1 and a means for connecting to a computer 3, that can consist of a wireless connection. It is equipped with a tuner 6′ connected to a satellite antenna 7′ or to a data distribution network, and with a packet demultiplexer for receiving digital data (possibly MPEG satellite flow). All of the digital flow inputs or outputs from and to the digital decoder 1, from and to the computer 3, and from the tuner 6′ are interconnected by a unit of the box 4, the routing unit 9. The routing unit 9 can be controlled by one or several means, such as the control panel on the box 4 itself (buttons, possibly a liquid crystal display), remote control or software installed in the computer 3 (therefore controlled at a distance if the protocol connecting the computer to the box is a wireless protocol). The routing unit 9 allows routing at least two independent flows of data so as to record or view a flow on the computer while watching a decoded program on the television set 2, or using the digital decoder 1 to view a flow received by the tuner 6′ of the box 4 while the flow received on the tuner 6 of the decoder is routed to the computer through the routing box. It also allows using the decoder to view a flow previously recorded on the computer.

The box 4 can be equipped with a chip reader 10 that can be controlled by an access control 11 loaded in the box 4 for unscrambling a flow received on the tuner of the decoder 1 and reintroduced either on the decoder itself, or on the computer 3 for viewing or recording. The access control 11 allows unscrambling an encrypted flow recorded on the computer 3, then routed from the computer to the decoder or to the computer screen itself (in this case, the flow exits the computer encrypted, is unscrambled in the routing box 4 and reintroduced to the computer unscrambled). The access control 11 also allows unscrambling a flow received on the tuner 6′ of the box 4 and to view, either on the televison set 2 or on the computer 3 (for instance, if the flow is a video show, one can use the MPEG2 decoder from the digital decoder 1, after unscrambling in the box 4, and if the flow corresponds to data such as encrypted internet pages, these are redirected instead to the computer 3 after passing through the access control 11. The chip reader 10 can also be controlled by an access control software 8 loaded on the computer 3 or in the digital decoder 1. In this case, the chip commands can use the box-decoder or box-computer connections to allow the software to communicate with the chip.

The tuners 6, 6′ and the antennas 7, 7′ will be adapted to the selected receiving mode (radio, satellite, cable, etc.).

The positioning of the various constitutive elements gives the object of the invention a maximum of useful effects which until now had not been obtained from similar devices.

1. Device for routing digital data flows adapted to control the digital transmission of all types of data, and in particular transmissions using packet coding constituted of a set of data routed in blocks in a network, whether radio, cable or satellite, characterized by a box (4) equipped with a tuner (6′) connected to a satellite antenna (7′) or to a data distribution network, means for connecting it to a digital decoder (1) and to a computer (3), as well as a routing unit (9) allowing to interconnect all of the digital flow inputs or outputs from and to the digital decoder (1), from and to the computer (3), and from the tuner (6′).

2. Device according to claim 1, characterized in that the box (4) comprises a packet demultiplexer for receiving digital data.

3. Device according to any of the preceding claims, characterized in that the box (4) comprises an access control (11) loaded in the box and capable of unscrambling a flow received on the tuner (6) of the digital decoder (1), on the tuner (6′) of the box (4) or recorded on the computer (3).

4. Device according to claim 3, characterized in that the box (4) comprises a chip reader (10) that can be controlled by the access control (11) loaded in said box.

5. Device according to claim 4, characterized in that the system is arranged such that the commands of the chip reader (10) can use the box (4)-digital decoder (1) or box (4)-computer (3) connections to be controlled by an access control software (8) loaded on the computer (3) or on the digital decoder (1).

6. Device according to any of the preceding claims, characterized in that the routing unit (9) allows routing at least two independent flows of data so that it is possible to record or view a flow on the computer while watching a decoded program on the television set (2), or to use the digital decoder (1) to view a flow received by the tuner (6′) of the box (4), while the flow received on the tuner (6) of the decoder is routed to the computer through the routing box.

7. Device according to any of the preceding claims, characterized in that the routing unit (9) allows using the digital decoder (1) to view a flow previously recorded on the computer (3).

8. Device according to any of the preceding claims, characterized in that the routing unit (9) is controlled by a control panel arranged on the box (4) or a remote control.

9. Device according to any of claims 1-7, characterized in that the routing unit (9) is controlled by a software installed in the computer (3).
